(19) United States
(12) Patent Application Publication
(10) Pub. No.: US 2014/0236684 A1
(43) Pub. Date: Aug. 21, 2014

(54) PARKING FACILITY MONITORING SYSTEMS, METHODS AND COMPONENTS AND REAL-TIME AUDITING OF PARKING OPERATIONS

(71) Applicants: Kosuke Nozawa, St. Anthony, MN (US); Nayeem Ahmed, Blaine, MN (US); Lawrence H. Feuer, Minnetonka, MN (US)

(72) Inventors: Kosuke Nozawa, St. Anthony, MN (US); Nayeem Ahmed, Blaine, MN (US); Lawrence H. Feuer, Minnetonka, MN (US)

(73) Assignee: AMANO McGann, Inc., Minneapolis, MN (US)

(21) Appl. No.: 13/823,356

(22) PCT Filed: Aug. 22, 2012
(86) PCT No.: PCT/US2012/051808

§ 371 Date: May 5, 2014

Related U.S. Application Data
(60) Provisional application No. 61/526,616, filed on Aug. 23, 2011.
(60) Provisional application No. 61/559,528, filed on Nov. 14, 2011.

(51) Int. Cl. G07B 15/02; G06Q 20/40

(52) U.S. Cl. CPC G07B 15/02; G06Q 20/401
USPC 705/13

(57) ABSTRACT

The present invention is directed to systems and methods for real-time auditing and management of parking facility operations. In particular, the invention allows for real-time auditing and management of transactions relating to parking credentials, such as parking tickets. The systems and methods eliminate the costly overhead of manual auditing, and also provide enhanced capabilities to further reduce both unintentional and intentional loses of revenue. The systems and method allow for “real-time” data analysis and offer the potential to catch discrepancies virtually instantly, and can provide alerts immediately for any identified discrepancies. The present invention is also directed, in part, to systems, methods, and components for monitoring a parking facility. The method and system include the use of parking tickets that are configured to receive multiple two-dimensional bar codes.

This application is being filed as a PCT International Patent application on Aug. 22, 2012, in the name of AMANO McGann, Inc., a U.S. national corporation, applicant for the designation of all countries except the U.S., and Kosuke Nozawa, a Japanese Citizen, Nayeem Ahmed, a Bangladesh Citizen, and Lawrence H. Feuer, a U.S. Citizen, applicants for the designation of the U.S. only, and claims priority to U.S. Provisional Patent Application Ser. No. 61/526,616, filed Aug. 23, 2011 and U.S. Provisional Patent Application Ser. No. 61/559,528, filed Nov. 14, 2011; the contents of which are herein incorporated by reference.

### FIELD OF THE INVENTION

The present invention is directed to systems and methods for real-time management and auditing of parking facilities and collecting parking fees. The invention further relates to improved systems and methods for tracking and recording user transactions relating to parking activities, and for collecting payment from persons parking their cars in parking facilities.

### BACKGROUND OF THE INVENTION

Pay parking facilities, such as parking facilities and parking lots, are very common, especially in areas where space is limited and there is a high demand for parking places. Urban areas, airports, train stations, sporting arenas, university facilities, municipalities, hotels, events, and many other locations have pay parking facilities, where vehicle drivers pay to park their cars. In many such pay parking facilities the cost of parking is based upon time, such as the number of hours that the vehicle has been parked in the facility: the longer the stay, the higher the bill. In other facilities parking is calculated on a flat rate, such as a single charge for all day parking, regardless of how long a vehicle is kept in the facility.

In addition to these fee structures, numerous other specialized parking rates and credits have been developed over time. For example, rather than just having a specific charge for a specific number of parking hours, sometimes different rates are charged depending upon what time a vehicle entered or exited a facility: there can be “early bird” discounts for people arriving before a certain time of day, as well as lower rates at off-peak periods, such as evenings in an office complex that is normally busy only during regular business hours.

Similarly, validation credits are often offered to vehicle drivers, such as credits for a certain number of hours of free parking if a person patronizes a local retailer (such as a department store), or for visiting a local service provider (such as a doctor). Examples include validated parking of two hours for visiting a local restaurant, or validated parking for a certain period of time for purchasing a minimum amount of merchandise at local stores.

In general, parking facility operators desire to have as much flexibility as possible in managing their parking facility: they want to have a great deal of flexibility in setting adjustable or tiered parking rates, they often want to be able to offer a variety of validation options, and they also want to offer vehicle drivers accuracy in fee calculations and efficiency in processing payments and exiting the parking facility.

It is important that transactions be as smooth and effortless as possible, so as to maximize customer satisfaction and ensure repeat parking: a driver who has to wait an inordinate amount of time to exit a facility as payments are calculated or processed is much less likely to return to that facility. Similarly, a driver who is forced to wait for an attendant to examine an ambiguous or flawed ticket, as well as other drivers caught behind this first driver, will be unhappy and less likely to return. In addition to satisfaction of drivers, it is desirable to have an efficient system so as to reduce labor costs: a system that requires fewer persons to monitor and operate will generally be a significantly more profitable facility.

Today the most common system for recording parking activity and determining parking facility charges involves the use of printed cards containing magnetically encoded strips along one edge of the ticket. Generally the magstripe will be encoded with an entry time and date, and then upon return to the parking facility a fee will be determined based upon time of entry and length of stay. If a validation is desired, it can be provided (for example) in the form of a sticker by a vendor stating how much time or money is to be credited against the charge. However, such stickers are non-magnetic and cannot be read by the equipment that reads the magstripe. Alternatively, the magstripe can be partially or completely rewritten with validation data, but this requires specialized equipment and is prone to error and is limited by data capacity on the magstripes.

Unfortunately, existing systems have significant shortcomings. For one, the magstripe on existing parking tickets is easily damaged or corrupted by contact with magnets—such as those used to close purses and pocket books. In addition, the limited data storage on conventional magstripes makes it very difficult to encode large quantities of data, such as multiple validations or complex payments (such as two partial payments made at different times). Another shortcoming is that it is difficult to validate parking tickets with magstripes unless the validator has specialized equipment to encode the strips—or validation stickers/stamps must be used which cannot be processed by the magstripe reading equipment. Furthermore, security can be an issue with existing magstripes, which do not contain enough data capacity to fully encrypt multiple transactions. The result of these shortcomings can be numerous, including the loss of parking revenue when the magstripes are damaged, increased labor costs (such as to review validation stamps), and increased hassle for customers (such as from damaged magstripes, delays in processing, etc.).

The high level of flexibility and the various fee structures and arrangements come with many benefits in the form of improved customer service, but they also have the downside of lost revenue through inadvertent errors and/or intentional fraud. For example, it is sometimes possible, using existing parking facility technology, to defraud the parking facility by altering parking tickets, or by creating counterfeit parking tickets and validations. In some situations parking attendants contribute to such fraud and theft. For example, an attendant can provide improper credits to a customer's transaction, thereby denying the parking facility its full proper revenue. Alternatively, the attendant can charge the full fee but manipulate the transaction to make it appear lower in the daily receipts, allowing the attendant to illegally pocket the difference. In addition, an attendant can seek to conceal various payments, such as cash payments, by diverting the payments from the cash receipts.

At the present time manual auditing and monitoring of parking operation reports are the primary options available to a parking operator to monitor and audit parking results. Unfortunately, such audits rely upon physical parking tickets that are not readily available for rapid review, and the manual audits are time consuming. It is necessary to undertake extremely time consuming manual audits of received parking tickets, and then try to compare those ticket records to expected receipts and revenue. All such reviews can only be undertaken long after the problem had occurred because the tickets are not reviewable until collected and manually examined. Even then, if a discrepancy is suspected, it is difficult to properly reach an accurate determination of error or fraud because of elapsed time and because the revenue itself is not tracked closely with regard to specific parking tickets. The consequence is that many transactions are never audited, or only occasional audits occur, and those audits often take place long after the transactions in question (generally days or months later). This failure to efficiently manage and carry out timely audit parking facility transactions cost significant amounts of money to facility operators on a daily basis.

Therefore, a need exists for an improved system and method for managing and auditing operations at parking facilities.

### SUMMARY OF THE INVENTION

The present invention is directed to systems and methods for real-time managing and auditing of parking facility operations, including sophisticated systems that allow remote “look-in” management of facilities and transactions from anywhere in the world. In particular, the invention allows for real-time auditing and management of transactions relating to parking credentials, such as parking tickets. Alternative credentials include, for example, hotel room keys used to access and exit parking facilities.

The systems and methods streamline and improve management, improve customer service, allow for immediate audits in real-time, eliminate the costly overhead of manual auditing, and also provide enhanced capabilities to further reduce unintentional and intentional loss of revenue. The systems and methods allow for real-time data analysis and offer the potential to catch discrepancies virtually instantly and automatically (such as by using artificial intelligence protocols, hereafter referred to as “AI”), thereby immediately alerting facility managers of identified discrepancies. In this manner the present invention has the ability to increase efficiency, improve customer service and reduce revenue embezzlement by cross checking and verifying transactions in real-time and with a high level of accuracy.

The invention is also directed to in part, to systems, methods, and components for monitoring a parking facility. The method and system include the use of parking tickets that are configured to receive multiple two-dimensional bar codes, with different bar codes printed for various activities, such as entering a parking facility, payment of parking fees, validation of parking fees, etc. The parking ticket contains space for at least 2 two-dimensional bar codes. Typically the parking ticket contains space for 6 or more two-dimensional bar codes.

The above summary of the present invention is not intended to describe each discussed embodiment of the present invention. This is the purpose of the figures and the detailed description that follows.

### FIGURES

The invention may be more completely understood in connection with the following drawings, in which:

FIG. 1 shows a parking ticket produced in accordance with the present invention, the parking ticket displaying multiple bar codes.

FIG. 2 shows a schematic representation of components of a parking system constructed and arranged in conjunction with an example implementation of the present invention.

FIG. 3 shows a schematic representation of elements of a system containing a parking facility information database and related system elements.

FIG. 4 shows a flow chart depicting example steps undertaken by a user from entry into a parking facility to exit from the parking facility.

FIG. 5 shows the flow chart of FIG. 4 showing example verification steps undertaken by the real-time auditing system of the invention.

FIG. 6 shows a parking ticket produced in accordance with the present invention, the parking ticket displaying multiple bar codes.

FIG. 7 shows a schematic representation of a parking system constructed and arranged in conjunction with an example implementation of the present invention.

FIG. 8 shows a first implementation of a parking ticket prior to use.

FIG. 9 shows a second implementation of a parking ticket prior to use.

FIG. 10 shows the back of a third implementation of a parking ticket, the parking ticket displaying a magstripe.

FIG. 11 shows the back of a fourth implementation of a parking ticket, the parking ticket lacking a magstripe.

FIG. 12 shows a parking ticket constructed and arranged in accordance with an implementation of the invention, the parking ticket displaying 6 two-dimensional bar codes.

FIG. 13 shows a parking ticket constructed and arranged in accordance with an implementation of the invention, the parking ticket displaying 2 two-dimensional bar codes.

FIG. 14 shows a parking ticket constructed and arranged in accordance with an implementation of the invention, the parking ticket displaying 3 two-dimensional bar codes.

FIG. 15 shows a first ticket with a validation stamp on it.

FIG. 16 shows a second ticket with a validation stamp on it.

FIG. 17A to 17E show a single parking ticket with a sequence of added two-dimensional bar codes. Specifically, FIG. 17A shows the ticket after dispensing from an entry station; FIG. 17B shows the ticket after having been validated with a printed validation bar code; FIG. 17C shows the ticket after validation with a sticker; FIG. 17D shows the ticket alter being processed at a walk up pay station, and FIG. 17E shows the ticket after being processed a second time at a pay station.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION

The present invention is directed to systems and methods for real-time auditing of parking facility operations. The systems and methods eliminate the costly overhead of manual auditing, and also provide enhanced capabilities to further reduce both unintentional and intentional loses of revenue. The systems and method allow for “real-time” data analysis and offer the potential to catch discrepancies virtually instantly, and can provide alerts immediately for any identified discrepancies. Thus, the present invention has the ability to reduce revenue embezzlement by cross checking and verifying transactions in real-time. In other words, cross checking and verifying of the transactions can occur immediately as they are processed from the entry to the exit of the parking facility.

The present invention provides for look-in technology that allows a remote monitor to oversee operations at a parking facility in real-time with a level of sophistication and accuracy that was not previously possible. The present invention allows for real-time auditing of tickets and revenue, identifying potential discrepancies quickly, thereby lowering the level of fraud but also correcting other unintentional problems as they arise. Further, the invention utilizes a networked searchable image database of the parking tickets. This database allows rapid, real-time review of each ticket's transaction or transactions, such as entry into the parking facility, payment, and exit. If the ticket is difficult to read or otherwise of interest to an attendant or manager, it can be immediately reviewed. The attendant or manager can quickly review the ticket and identify problems and remedies: such as damage to the ticket or evidence of tampering with the ticket. The imaging of the parking tickets and subsequent decoding of encrypted data printed on the tickets provide a significant benefit. In addition, the image can be immediately remotely reviewed by one or more attendants or managers: not just the data on the ticket, but the ticket itself can be reviewed because images of the ticket are transmitted. In certain embodiments the invention uses electronic images tied to each transaction at a host server database to perform the following tasks: confirm data from ticket image equals the database transaction data; confirm calculated fees from ticket image are equal to the calculated fees based on records in the database; confirm that the entire fee is charged; and confirm expected payments are equal to any credit card transaction confirmation or other payment received. When discrepancies arise the invention can immediately raise alarms of suspicious transactions, allowing for immediate review and resolution.

In addition to allowing immediate review of transaction data as the transaction occurs, the present invention allows for aggregate analysis of data to identify potential theft or errors: Transactions can be searched and analyzed by date, location, attendant, etc. This allows for the identification of otherwise unnoticed discrepancies. An example of this would be a situation where an individual attendant has a significantly high level of defective or unreadable parking tickets. This can be an indication of fraud, because over an extended period of time the level of such defective tickets would be expected to be similar between attendants.

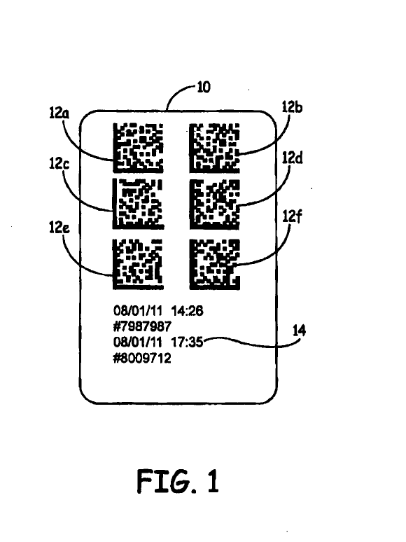

This level of sophisticated problem resolution—proceeding from basic data capture and review, to data analysis (such as via AI), and then leading to human intervention is actually extremely rapid: The first two steps can be essentially instantaneous to the user. The image is rapidly captured and processed. In just a matter of seconds all capturing is completed, basic processing is done, and any AI analysis is completed. It may be that no human intervention is necessary, but to the extent it is necessary, the user can get immediate assistance from a human being. With regard to AI technology, it will also be understood that such technology can have a learning element, so that new problems that are identified can be communicated to other facilities for consideration. For example, if a certain technique is devised for generating counterfeit tickets, the AI system can be updated (either autonomously or manually) with information as to how such counterfeit tickets can be recognized. Thus, the system of the present invention is highly dynamic. In reference now to the drawings, FIG. 1 shows a parking ticket 10 that may be used in accordance with the present invention. The parking ticket 10 shows multiple two-dimensional bar codes 12a to 12f Parking ticket 10 also includes, in the depicted embodiment, a limited number of rows 14 of text printed on the parking ticket 10. These rows 14 of text can provide confirming information from the bar codes, such as date and time of entry into a parking facility, as well of date and time of exit (for example) from the parking facility.

The parking ticket 10 is typically issued to a driver at the entrance gate to a parking facility. At that point the issued ticket will generally display just one or two bar codes, rather than the six shown here. The ticket may also display an entrance time, such as the time “08/01/11 14:26” shown in FIG. 1. The other bar codes are generally added for subsequent transactions, such as to add validation amounts (credits against the parking fees), or to indicate that that parking fees have been paid in full. The bar codes are typically encrypted so as to limit the ability of third parties to determine the information on the parking ticket. This encryption of the data on the parking tickets provides an initial level of security for the parking facility.

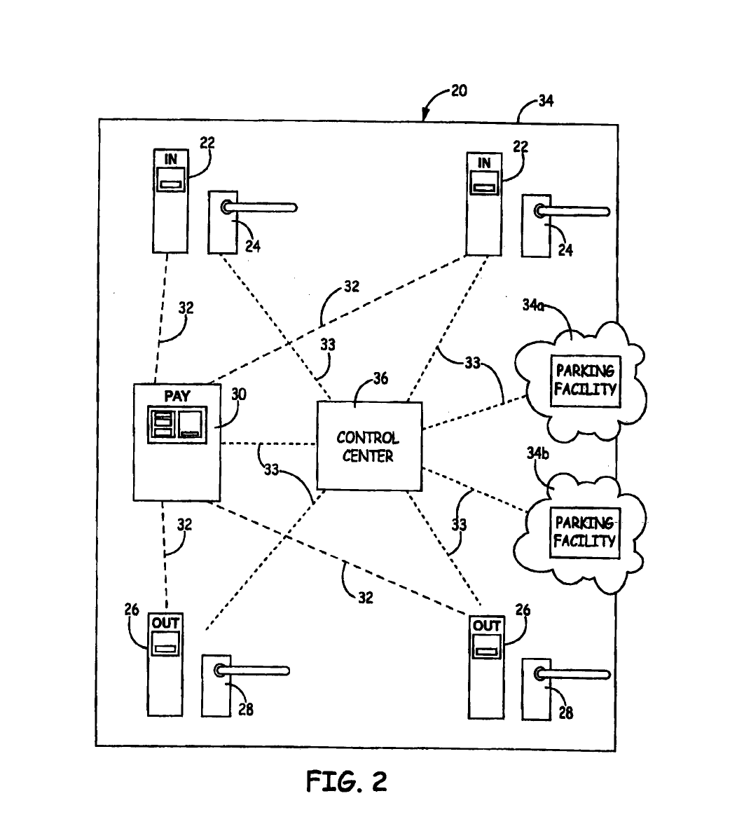

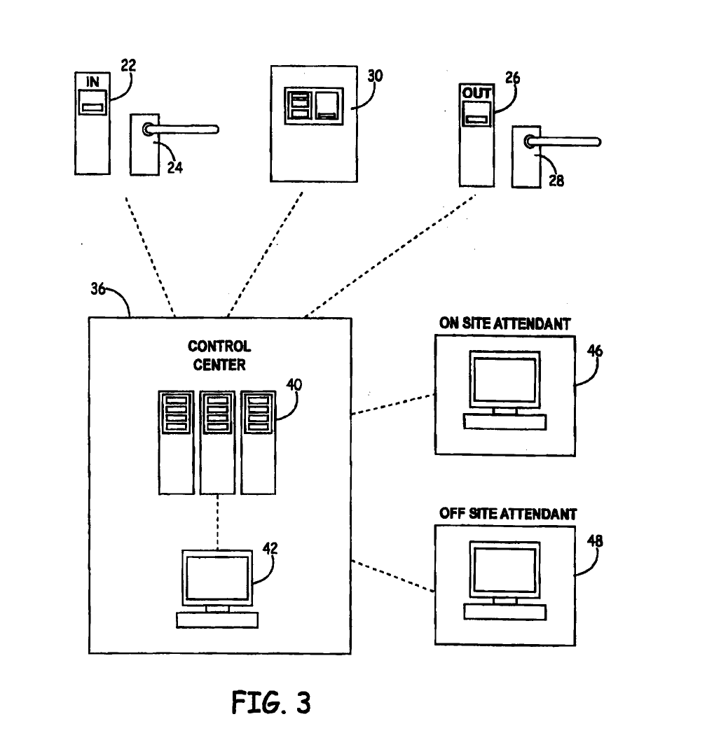

Each issued parking ticket 10 will generally have an identifier associated with it, so that the real-time audit systems and methods of the invention can track this ticket through the process of entry, parking and exit from the parking facility. Thus, rather than merely state a specific time at which the parking ticket was issued, the parking ticket 10 will indicate the specific ticket and specific time (in encrypted information, typically). This ticket information is communicated to a control center (see FIG. 2 and FIG. 3, below) containing a host server with database functionality. From this point on, movement of the ticket, including most or all subsequent transactions involving the ticket, can be carefully and accurately tracked using the system and methods of the invention.

After the ticket 10 is issued, access is granted to the driver to enter the parking facility. Typically this access is granted by the opening of a gate arm, although alternative access controls can be used, such as the opening of a garage door. The opening of the access control, such as the garage door or gate arm, can also be recorded at this time and communicated back to a host server. However, generally access is granted immediately after the ticket is requested and there is no need for further confirmation that access has been granted. After access to the parking facility has been granted the driver enters the facility, parks, and can leave their vehicle.

After a period of time the driver will desire to exit the facility. To leave the facility the driver will need to pay his or her parking charges, and then leave the facility through an exit. Payment of the parking charges occurs, for example, at a pay station in the parking facility. The ticket 10 is inserted into the pay station, which takes a digital image of the parking ticket and then decodes the information and compares it to the database record of when this ticket was issued at the parking facility. The digital image is typically a bitmap or a raster image, and can be saved and processed in one or more different formats, such as a TIFF or a JPEG file. In some implementations the digital image is a color image, while in other implementations the digital image is gray scale or black and white. In general the digital image will be compressed to preserve storage space.

At this point a first verification step is typically undertaken to identify any discrepancies, such as (for example): is the ticket recorded in the database; and does the time between issuance and return of the ticket match the records in the database. If the ticket is not in the database, then an error situation is identified. Similarly, if there is a time discrepancy, an error situation is identified. An example of an error situation can include a ticket that is damaged or otherwise not readily readable. In addition, an error situation can arise if an improper ticket is inserted—such as a ticket for another parking lot, a different vendor ticket, or even a credit card. The present invention, by capturing an image of the ticket, allows for easy recognition as to whether the inserted ticket is even proper. For example, if an initial review indicates that the ticket is not processable using ordinary methods, an AI module can be used to identify the problem and possible resolution.

The systems and methods of the invention are preferably constructed so as to be self-healing, in that faults or error conditions can be automatically corrected. For example, if a common error in a ticket is identified, along with a common solution, the system and methods allow for future processing of similar tickets using the common solution. An example of this is recognition of a defective validation stamp that should be entitled to no validation credit (such as a validation stamp for a different facility or a validation stamp that has expired). Upon recognition of the defective stamp, the system can be made to look for similar stamps in the future. Alternatively, if a portion of the system becomes inoperable (such as failure of an optical character recognition (OCR) function), the system can rely upon alternative methodologies to process the tickets until OCR functionality is restored. Such alternative methodologies, undertaken as part of the system self-healing, can include reliance on only the bar code information, or even temporary reliance upon human operators (located at the facility or remotely) to review any tickets in need of OCR examination.

For example, the AI module can be used to review the image for other information—such as evidence that the ticket is actually a credit card (by identifying the name of a credit card company, for example). Alternatively, or in addition, the ticket image can be instantly reviewed by a human to determine the reason for the error. The human, who can essentially be located anywhere in the world, is able to review an image of the ticket and propose a resolution. For example, if the ticket is damaged the human can look for date and time stamps (if present) for evidence of when the ticket was issued. This information can optionally be recognized using optical character recognition (OCR) software.

Other discrepancies besides a time discrepancy can include, for example, if the ticket with the same identifier has already been shown to have been used to have exited the parking facility. This scenario can arise if a ticket was fraudulently duplicated. This can occur if the driver of a long-parked vehicle attempts to use a duplicate of a parking ticket issued to a more recently park vehicle. By tracking each ticket through the system, and then looking for discrepancies, it is possible to prevent this situation from arising by simply refusing to process the duplicate ticket. Because the system and methods of the invention track each ticket individually through the parking process using encrypted identifiers, such duplication becomes particularly difficult.

Assuming no discrepancy is found in the ticket at the time the ticket is submitted for payment, then a payment value is calculated and is requested from the driver. Payment can then be made by one or more various means: credit card payment, cash, voucher, near-field wireless connection to a mobile device, etc. Real-time audit of this aspect of the transaction also typically occurs to confirm that the requested payment amount corresponds exactly to the amount paid. If a discrepancy arises, then further payment can be requested or other resolution sought. For example, a live attendant can intervene in person or over remote phone or video connection to communicate with the driver to resolve the issue.

After payment is made, the user may receive their parking ticket back, typically with a new bar code printed on it, the new bar code showing the time payment was made and the amount provided. Alternatively, a new ticket may be provided with a new bar code containing information about the transaction (entry time, payment, etc). As noted above, at this point the system communicates back to the host server and validates that the proper amount of money has been requested and paid, as well as the form of payment received. The user then takes their vehicle and the ticket to the exit of the parking facility, and inserts the ticket into a reader (such as in each exit lane in close proximity to a gate). Once again at this exit the ticket can be imaged and the image and data is sent to the central server to confirm all payments have been properly made and that the vehicle should be allowed to exit the facility.

In aggregate, these steps serve to carefully track and audit the parking transaction from start to end, provides a high level of security in the transaction and avoids errors and fraud. In addition, the existence of the system increases the deterrent effect because persons with the intent to defraud the system are more likely to understand in advance that transactions are controlled, monitored, and audited. This is likely to deter drivers from seeking to defraud the lot, but also provides a significant deterrent effect to employees who will now understand their ability to conceal fraudulent activity is greatly reduced.

FIG. 2 shows a simplified schematic representation of a parking system 20 constructed and arranged in conjunction with the present invention. The parking system 20 can be used with the parking ticket 10 shown in FIG. 1, but can also be used with alternative parking credentials that allow tracking. The parking system 20 can include, for example, multiple entrance stations 22, entrance gates 24, exit stations 26, and exit gates 28. Other elements of the system can include a pay station 30, also referred to as a “pay-on-foot” central pay station. It is possible to include features such as an exit pay station, an exit cashier, valet kiosk, event handhelds, etc. to further add to the options for processing parking tickets. All of these devices will desirably have the ability to interface with the audit server database of the invention, although it is acceptable to have some such devices outside of the audit system when necessary. It is generally desirable that there be communication of some sort between the various components, as represented by example communication lines 32 and 33. These communication lines are provided for illustrative purposes only—various other communication systems can be provided, as well as wireless connections.

These components of the parking system 20 are all typically housed within a parking facility 34. It will also be understood that in some implementations there will be a centralized control center 36 for managing the various components of the parking system 20. This centralized control center 36 may control operations at one parking facility 34, or can optionally be connected to additional parking facilities, such as facilities 34a or 34b that can be remotely located. In the centralized control center 36 will typically be one or more servers that host a parking database in communication with components of the real-time audit system. Further, it will be understood that the control center 36 can be, in practice, a distributed network whereby equipment and servers are located at multiple facilities. Thus, the function of the system to monitor and audit transactions is more essential than the physical configuration or the actual networking arrangement.

The present invention provides for look-in technology that allows a remote monitor to oversee operations at a parking facility in real-time with a level of sophistication and accuracy that was not previously possible. The imaging of the parking tickets and subsequent decoding of encrypted data printed on the tickets provide a significant benefit. In addition, the image can be immediately remotely reviewed by one or more attendants or managers: not just the data on the ticket, but the ticket itself can be reviewed because images of the ticket are transmitted. If the ticket is difficult to read or otherwise of interest to an attendant or manager, it can be immediately reviewed and handled. The attendant or manager can quickly review the ticket and identify problems: such as damage to the ticket or evidence of tampering.

In addition to transmitting the actual ticket image, it is possible to initiate communications with the vehicle driver, such as over a voice over internet protocol (VoIP) connection. It is also possible, when desired, to record related information along with the ticket image. This information can include, for example, a photograph of the driver and/or vehicle, which can be useful in auditing problems at a parking facility. In addition, in certain implementations communications with attendants by voice can be recorded and associated with the ticket. Optionally such communications can be reviewed and analyzed using voice recognition software. The retention of such files—photos, voice records, video surveillance, etc.—are optional and won't be used in all implementations, but provide an option for enhanced record keeping, remote management, and more detailed audit trails. One potential issue with recording such information involves the privacy of such data. However, this is typically not a significant problem because the saved data involves communications made in public with no expectation of privacy, and also don't generally exceed the information typically already recorded by surveillance cameras. In some implementations such information is recorded only at certain times, such as upon pushing an intercom button or for a short period upon entering a parking facility.

In use, a vehicle will typically enter the parking facility by way of one of the entrance stations 22 and entrance gates 24. At the entrance station 22 a vehicle driver will typically either request a parking ticket, or be automatically given a parking ticket. The parking ticket's issuance is communicated to the database and recorded. The parking ticket will typically contain a bar code, normally a two-dimensional bar code, printed on a portion of the ticket. This initial bar code will generally contain encrypted information relating to the date and time of entry, as well as location. This initial bar code will generally be printed so as to cover just a small percent of the surface of the ticket, so as to allow the printing of subsequent bar codes on remaining portions of the ticket (as discussed below).

Upon return to the parking facility, the driver can proceed to the central pay station 30, where an imaging device captures a digital photographic representation of the bar code (or codes) on the ticket, processes/extracts the necessary encoded information, and then calculates any parking fees that are due. At the same time, or at least soon in time, this information is communicated to the database and records are compared for errors or discrepancies. The central pay station 30 permits making payment of the parking fees, such as by accepting cash or credit card payments (as well as other electronic payment methods, in some implementations).

Each of the pay stations 30 and exit stations 26 contain an imager that can capture images of one or both sides of a parking ticket on which bar codes have been printed or otherwise secured. The image, such as a JPEG, TIFF, or other raster image, is subsequently processed to determine the content of the two dimensional bar code. This processing can occur at various locations: in some implementations the processing will occur at the pay station 30. It is also possible for the processing to occur at the exit station 26. Alternatively, the processing can occur at a centralized control center 36. Notably, the control center 36 can be located onsite (in or near the parking facility 34), or can be located off-site as long as communication with the control center is possible. Also, the control center 36 can optionally control more than one parking facility. In addition to processing of the image, it is often desirable to retain the image for future records, for audit purposes, etc.

After the image is processed so as to retrieve the data on each of the bar codes, then the total fees due are calculated, and the information is checked against database records to confirm no discrepancies exist. The fees may depend, for example, on entry and exit time, length of stay, validations, etc. The user is informed about the amount due, such as by a computerized display, and then the user is given an opportunity to pay the amount due. When this payment is given at the pay station 30, the parking ticket is typically returned to the user along with a new printed bar code stating that the fees have been paid. This ticket is subsequently processed at the exit station 26, which images the ticket, decodes the bar codes, and raises the exit gate 28 upon confirming that all payments have been made. In some cases the bar code will then be returned to the user, along with an indication of how much was paid, so as to provide a receipt for the transaction.

Upon making payment at the central pay station 30, the parking ticket is typically returned back to the driver, but is first encoded with an additional two-dimensional bar code stating the amount of money which has been paid (or, alternatively, that the full amount of money due has been paid, along with when the payment was made). Thereafter, the driver proceeds to their vehicle and drives to an exit station 26. At the exit station 26 the driver inserts their ticket, which is again captured by an imaging device that captures a digital photographic representation of bar codes on the ticket, and this information is transmitted to the database. The exit station 26 (or control center 36, both, or another processing system) calculates whether all fees have been paid properly and whether there are any indications of fraud or other discrepancies, and then opens the exit gate 28. Normally no fees will be due at this point, because the vehicle driver has just completed payment at the central pay station 30 and has left within a defined grace period (such as half an hour). However, in some implementations more fees might will be due, such as if the driver allowed an extended period of time to pass before the vehicle reaches an exit station 26 (for example, more than half an hour or an hour). If additional fees might be due, they can be paid (for example) by inserting a credit card or cash to pay the remaining amount due, or by allowing the parking system to charge the same credit or debit card (if one was used) that had been charged at the pay station 30.

In the depicted embodiment the pay station 30 and exit station 26 do not include attendants because payment is easily made without an attendant on site. The system and methods of the invention are used to audit and review all transactions in real-time. However, it will be understood that the current system can also be used with an attendant, either at the exit station 26 or the central pay station 30. Most typically that attendant will be located at the exit station 26. Many parking facilities contain more than one exit station 26, and therefore it is sometimes appropriate to have an attendant at just a portion of the exit stations to be able to handle any questions or problems that arise. It will be understood, however, that the present invention provides the significant advantage of allowing a parking facility 34 to function without an onsite attendant. Referring now to FIG. 3, further details and additional elements of the real-time audit system is shown. The control center 36 includes one or more servers 40, and a client computer 42. The servers 40 host the database containing parking ticket information, while the client computer 40 provides an example way of accessing the servers. Example entrance station 22 and entrance gate 24 are shown, along with a central pay station 30, and an exit station 26 and exit gate 28. As described above, each of these devices can be configured to communicate with the servers 40: the entrance station 23 issues parking tickets with encrypted bar codes and then communicates this information to the control center 36; the central pay station 30 images and reads the bar codes and communicates with the servers 40 to determine whether any discrepancies are present; the exit station 26 also images the bar codes and communicates with the servers 40 to confirm there are no discrepancies on the ticket.

In addition to these components, schematic representations are shown of an onsite attendant station 46 and an offsite attendant station 48, who have access to the data in the servers 40. Each attendant station 46, 48 has available a client computer having access to the servers 40, allowing attendants to review each parking ticket's individualized information, which can resolve discrepancies and identify fraud. It will be noted, however, that the system does not necessarily rely upon these attendants to identify fraud, since it can be the attendants themselves who are sometimes involved in the improper activity. Rather, the present invention retains key information for each ticket, including multiple images of it, which allows a person other than the attendant to undertake the audit in real-time and/or after the transaction. Many audit functions are automated, but the system also allows a person to quickly review all necessary records in real-time to further enhance the audit performance.

Generally it is desirable to have the audit functions be undertaken so as to enhance automatic management of the parking facility to the greatest extent possible, and in particular to allow for sophisticated real-time oversight and audit of parking functions. Such management and audit functions are made possible by the present invention: capture of the digital image of the parking ticket provides an opportunity for enhanced review and analysis of each ticket. This review initially includes, at a minimum, automatic decoding of encrypted information on the parking ticket (such as a two-dimensional bar code). In addition, this initial processing can optionally include recognition of text printed on the ticket, if any is present. This text can include text printed on the ticket with entry and exit times (for example). Optical character recognition (OCR) of this text can be useful for confirming the encrypted data on the ticket, especially if the veracity of any of the data is for some reason questioned.

The initial processing also can include review of other information on the parking ticket—such as facility name. This aggregate data—encrypted bar code data, optical character recognition (OCR) information, facility name, etc. can all be processed using AI techniques to quickly and accurately identify problems. For example, invalid tickets can be spotted and returned, optionally with an explanation to the user about the problem. For example, if the ticket is for the wrong parking facility, the system can inform the user of this problem rather than just saying the ticket is defective. In an example exchange the ticket is returned to the user and told with a voice or visual prompt that the ticket is incorrect because it is for different lot. Using AI it is possible to even carry on a quick conversation with the user to resolve the problem: For example, if the user responds that they are in the right lot, the system can prompt the user to confirm that they grabbed the correct ticket from their vehicle.

In this manner the present invention allows for a first step in which data is gathered and initially processed—the where, when, how much, etc. information essential to parking facility management. It also then allows for a second step of error recognition and problem resolution: use of algorithms, such as AI protocols, to quickly resolve some of the most common problems associated with parking facility operations.

Third, the invention allows for immediate intervention of a human being if either of these first two steps does not produce a rapid and complete resolution to any problem. For example, if the AI module cannot quickly identify a resolution, then a human can intervene quickly. The benefit at this point in the process is that the human's intervention can be enhanced by the first two steps: the human is able to view in real-time an image of the ticket, and can also be given cues as to what the likely problem is (such as a soiled ticket).

This level of sophisticated problem resolution—proceeding from basic data capture and review, to data analysis (such as via AI), and then leading to human intervention is actually extremely rapid: The first two steps can be essentially instantaneous to the user. The image is rapidly captured and processed. In just a matter of seconds all capturing is completed, basic processing is done, and any AI analysis is completed (if AI analysis is to occur). It may be that no human intervention is necessary, but to the extent it is necessary, the user can next get immediate assistance from a human being. Thus, the user won't even notice that all of these steps are being undertaken in the background.

This immediate assistance is possible for a few reasons: first, the automation of most analysis allows for attendants to only handle the most difficult exception cases that cannot be automatically resolved. Thus, rather than having attendants handle dozens of standard transactions in an hour, they can focus on less frequent non-standard problems. With fewer transactions to handle, the attendant is free to give better service on the truly difficult problems. A second reason for the improved assistance is that the present invention allows for offsite attendants to review parking facility transactions in a command center. This allows for busy parking facilities to have a far more elastic supply of attendants because offsite attendants can be used. For example: a group of ten commonly managed lots can have a single command center that has numerous attendants available to handle workflow. If one parking facility is very busy (say it is located near a sports stadium, and fans are entering or exiting the facility just before or after an event), then extra attendants may be available at the central control station. Alternatively, attendants onsite at the other facilities can be used to resolve issues. Thus, the present invention allows for a distributed workforce that can readily respond to changes in the need for attendants across multiple facilities.

In this manner it is not necessary to have each facility staff up for peak workload, but rather have the overall system ready for those peak workloads. It is possible to have very significant savings of labor costs in such arrangements, as illustrated by the following example: If a system includes three parking facilities that have different peak hours, and those facilities need three attendants at peak hours, but only one at off-peak hours. Under current technology it might be necessary to have nine attendants in order to be prepared for peak workloads at each facility. However, with a centralized management system enabled by the current invention it can be possible to have just five attendants: at any given time they can effectively have one attendant dedicated to each facility's regular workload, plus two more attendants to handle peak workloads at the facilities, as they each get busy and/or slow down. In large systems with high numbers of facilities even more efficient staffing can occur, especially if facilities are operated in multiple time zones. The result can be a significant benefit in customer service while providing the opportunity for reduced costs.

Besides these benefits of responsiveness and accuracy of transaction handling, the present invention allows for remote management that enables real-time auditing of a complete audit trail. A manager (or an AI management module) can look in real-time at problems or suspected problems: Tickets and related information from the transaction (such as audio and video files) can be instantly examined and reviewed. As noted above, even voice communications with customers can be reviewed in real-time. This system thus allows for a “look-in” system that allows offsite assistance and management of facilities from anywhere in the world. Combined with real-time, sophisticated audits, as well as error processing, the result is a streamlined facility that offers improved customer service, opportunities for reduced fraud (and thus improved profits), and lower labor costs (also resulting in improved profits).

With regard to AI technology, it will also be understood that such technology can have a learning element, so that new problems that are identified can be communicated to other facilities for consideration. For example, if a certain technique is devised for generating counterfeit tickets, the AI system can be updated (either autonomously or manually) with information as to how such counterfeit tickets can be recognized. Thus, the system of the present invention is highly dynamic and self-healing.

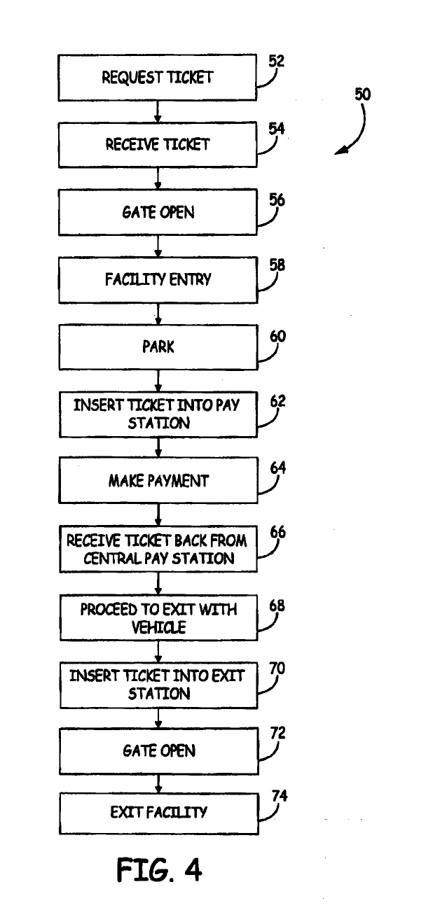

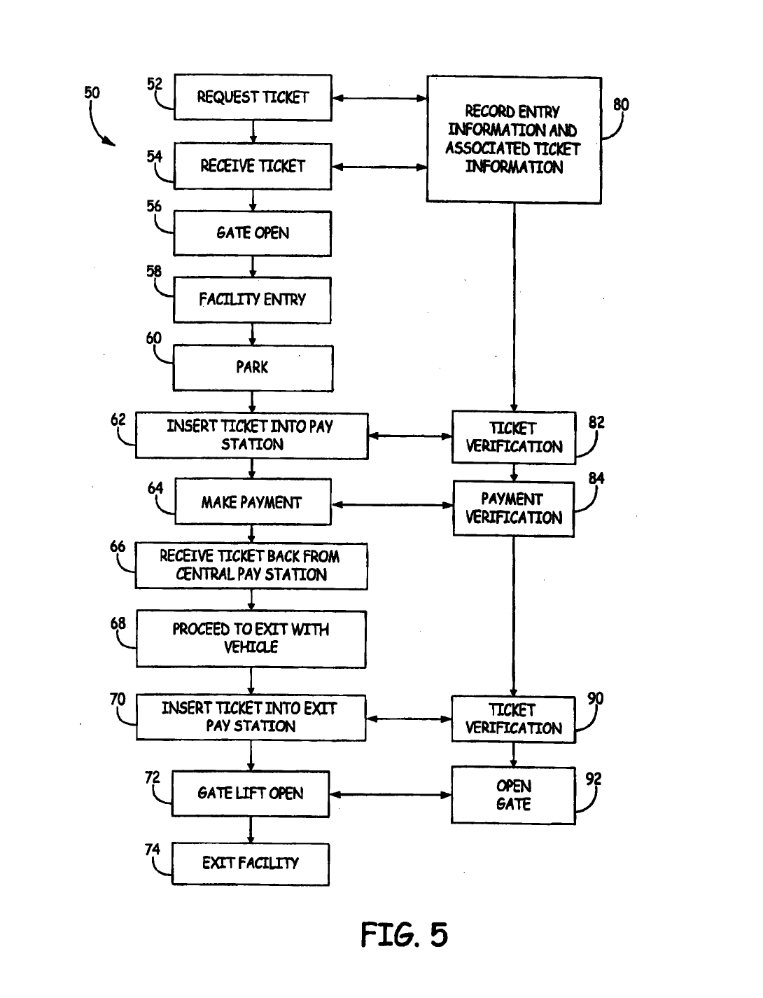

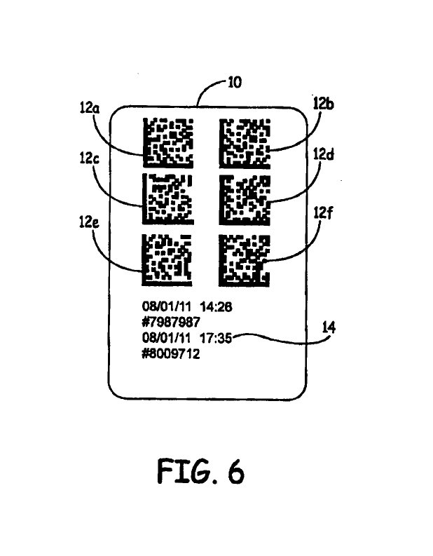

Referring now to FIGS. 4 and 5, example flow charts are provided to indicate typical process steps for parking and auditing. In FIG. 4 the steps undertaken by a driver are shown, while FIG. 6 shows those same steps, along with the real-time audit steps performed simultaneously, using the system and method of the invention. Referring first to FIG. 4, the first step is typically requesting a ticket at step 52, which is printed and received by the driver at step 54. The parking ticket typically shows multiple two-dimensional bar codes. The parking ticket can also include a limited number of rows of text printed on the parking ticket. These rows of text can provide confirming information from the bar codes, such as date and time of entry into a parking facility, as well of date and time of exit (for example) from the parking facility, and can be used as part of the audit process because they are imaged along with the bar codes and can be reviewed using optical character recognition (OCR) software.

Each issued parking ticket will generally have an identifier associated with it, so that the system of the invention can track this ticket through the process of parking and redemption upon exit from the parking facility. Thus, rather than merely stating a specific time at which the parking ticket was issued, the parking ticket will indicate (in encrypted information, typically) the specific ticket identifier.

After the ticket is issued, access is granted to the driver to enter the parking facility. Typically this access is granted by the opening of a gate arm in step 56, although alternative access controllers can be used, such as the opening of a garage door. The opening of the access controller can also be recorded at this time and communicated back to a host server. However, generally, access is granted immediately and there is no need for further confirmation that access has been granted. After access to the parking facility has been granted the driver enters the facility in his or her vehicle, parks, and can leave their vehicle at step 60.

Later, in order to exit the facility the driver will need to pay their parking charges, and then leave the facility through an exit. Payment of the parking charges can occur at a pay station, starting with step 62 of inserting a ticket into a pay station and making payment in step 64. At this point a payment is requested in step 64. After payment is made the user can receive their parking ticket back, typically with a new bar code printed on it, the new bar code showing the time payment was made and the amount provided, in step 66. Thereafter, assuming proper payment has been made, the ticket is imprinted with a bar code indicating that the fees have been paid and then the ticket is returned to the user. The user then takes the ticket to the exit of the parking facility in step 68, and inserts the ticket into a reader (such as in each exit lane in close proximity to a gate) in step 70. The gate is opened in step 72, and the user exits the parking facility in step 74.

In addition to these steps performed by the user of the system, background audit and review activity is also happening to provide a real-time audit of the parking activities and transactions, as shown in FIG. 5: At the time of requesting and receiving the ticket (steps 52 and 54), the ticket information, along with its photographic image, is sent to a server in step 80, where the data is stored until later when a user wishes to leave the parking facility. When the user returns, the ticket is inserted into the central pay station, which takes a photographic image of the parking ticket and then decodes the information and compares it to the record of when this ticket was issued at the parking facility. At this point a first verification step 82 is typically undertaken to identify any discrepancies, such as: is the ticket recorded in the database; and does the time between issuance and return of the ticket match the records in the database. If the ticket is not in the database, then an error situation is identified. Similarly, if there is a time discrepancy, an error situation is identified. If there is no underlying problem with the ticket, payment is requested and made, at which time a second verification step is performed, this time involving payment verification in step 84. Finally in step 90 a final verification step can be performed when the ticket is inserted into an exit station, where the ticket is again reviewed for discrepancies. In particular, it is generally desirable at this point to check the lag time from when the payment was made at step 64 to when the ticket was inserted into the exit pay station at step 70. For example, a ten minute lag can be allowed to permit the driver to get into their vehicle and drive to the exit pay station. If a longer time is taken the system can charge the driver additional fees to cover the additional time. Typically the system will also inform the driver of the additional charges, and can optionally provide an updated receipt. The system can also look for any other discrepancies. Assuming no discrepancies are found, then the gate open step 72 occurs in response to an open gate instruction at step 92.

It will also be understood that when the ticket information and photographic image of the ticket are stored, they will be digitally time stamped with a unique identifier/signature which will authenticate the image's data and allow the identifier/signature to be used in manual or automatic audits. This digital identifier/signature is embedded as part of the file which makes it tamperproof. Any alteration of data within this file is protected via hashes, so that if someone changes the data, such changes can be detected by checking this digital identifier/signature. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The invention is also directed to, in part, to a method and system for monitoring a parking facility, the method and system include the use of parking tickets that are configured to receive multiple two-dimensional bar codes, with different bar codes created for various activities, such as entering a parking facility, payment of parking fees, validation of parking fees, etc. Typically the parking ticket contains space for 2 or more two-dimensional bar codes.

In reference now to the drawings, FIG. 6 shows parking ticket 10 produced in accordance with the present invention, the parking ticket showing multiple two-dimensional bar codes 12a to 12f. Parking ticket 10 also includes, in the depicted embodiment, a limited number of rows 14 of text printed on the parking ticket 10. These rows 14 of text can provide confirming information from the bar codes, such as date and time of entry into a parking facility, as well of date and time of exit (for example) from the parking facility.

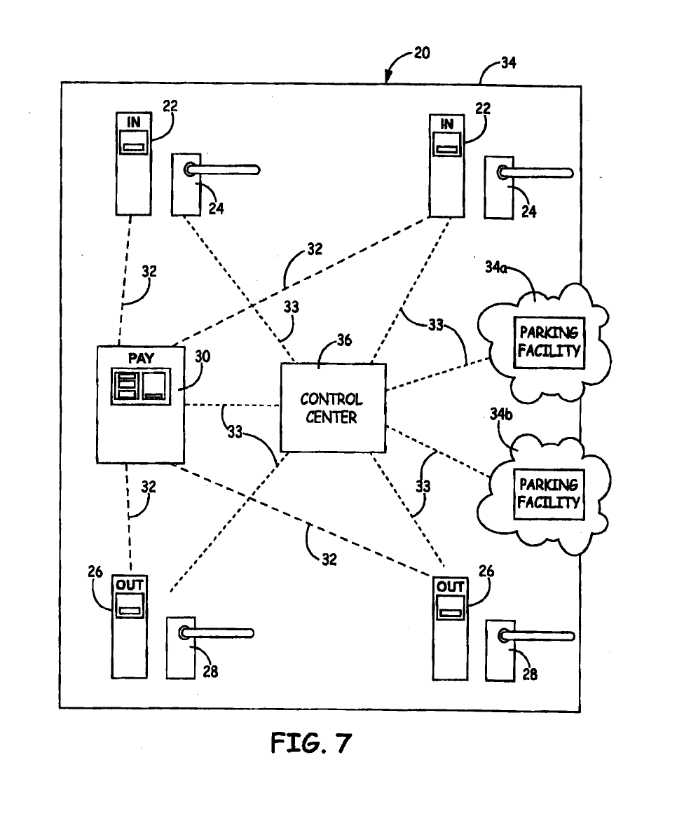

FIG. 7 shows a simplified schematic representation of a parking system 20 constructed and arranged in conjunction with the present invention. The parking system 20 can be used with the parking ticket of the present invention. The parking system 20 can include, for example, multiple entrance stations 22, entrance gates 24, exit stations 26, and exit gates 28. Other elements of the system can include a pay station 30, also referred to as a “pay-on-foot” central pay station. It is also possible to include features such as an exit pay station, an exit cashier, valet kiosk, event handhelds, etc. to further add to the options for processing parking tickets. It is generally desirable that there be communication of some sort between the various components, as represented by example communication lines 32 and 33 (these communication lines are provided for illustrative purposes only—various other communication systems can be provided, as well as wireless connections).

These components of the parking system 20 are all typically housed within a parking facility 34. It will also be understood that in some implementations there will be a centralized control center 36 for managing the various components of the parking system 20. This centralized control center 36 may control operations at one parking facility 34, or can optionally be connected to additional parking facilities, such as facilities 34a or 34b that can be remotely located.

In use, a vehicle will typically enter the parking facility by way of one of the entrance stations 22 and entrance gates 24. At the entrance station 22 a vehicle driver will typically either request a parking ticket, or be automatically given a parking ticket. The parking ticket can be one such as those shown in FIG. 3 or FIG. 4, discussed more completely below. The parking ticket will typically contain a bar code, normally a two-dimensional bar code, printed on a portion of the ticket. This initial bar code will generally contain encrypted information relating to the date and time of entry, as well as location. This initial bar code will generally be printed so as to cover just a small percent of the surface of the ticket, so as to allow the printing of subsequent bar codes on remaining portions of the ticket (as discussed below).

In the most basic operation a vehicle driver will then proceed to park their vehicle, and can either leave the ticket in their vehicle or can take it with them when they leave their vehicle. Upon return to the parking facility, the driver can proceed to the central pay station 30, where an imaging device captures a digital photographic representation of the bar code (or codes) on the ticket, processes/extracts the necessary encoded information, and then calculates any parking fees that are due. The central pay station 30 permits making payment of the parking fees, such as by accepting cash or credit card payments (as well as other electronic payment methods, in some implementations).

Upon making payment at the central pay station 30, the parking ticket is typically returned back to the driver, but is first encoded with an additional two-dimensional bar code stating the amount of money which has been paid (or, in the alternative, that the full amount of money due has been paid, along with when the payment was made). Thereafter, the driver proceeds to their vehicle and drives to an exit station 26. At the exit station 26 the driver inserts their ticket, which is again captured by an imaging device that captures a digital photographic representation of bar codes on the ticket. The exit station 26 (or control center 36 or another processing system) calculates whether all fees have been paid, and then opens the exit gate 28. Normally no fees will be due at this point, because the vehicle driver has just completed payment at the central pay station 30 and has left within a defined grace period (such as half an hour). However, in some implementations more fees might be due, such as if the driver allowed an extended period of time to pass before the vehicle reaches an exit station 26 (for example, more than half an hour or an hour). In some circumstances additional fees might be due, and can be paid (for example) by inserting a credit card or cash to pay the remaining amount due, or by allowing the parking system to charge the same credit or debit card (if one was used) that had been charged at the pay station 30.

Each of the pay stations 30 and exit stations 26 contain an imaging scanner that can capture images of one or both sides of a parking ticket on which bar codes have been printed or otherwise secured. The image, such as a JPEG, TIFF, or other raster image, is subsequently processed to determine the content of the two dimensional bar code. This processing can occur at various locations: In some implementations the processing will occur at the pay station 30. It is also possible for the processing to occur at the exit station 26. Alternatively, the processing can occur at a centralized control center 36. Notably, the control center 36 can be located on-site (in or near the parking facility 34), or can be located off-site as long as communication with the control center is possible. Also, the control center 36 can optionally control more than one parking facility. In addition to processing of the image, it is often desirable to retain the image for future records, for audit purposes, etc.

After the image is processed so as to retrieve the data on each of the bar codes, then the total fees due are calculated. These fees may depend, for example, on entry and exit time, length of stay, validations, etc. The user is informed about the amount due, such as by a computerized display, and then the user is given an opportunity to pay the amount due. When this payment is given at the pay station 30, the parking ticket is typically returned to the user along with a new printed bar code stating that the fees have been paid. This ticket is subsequently processed at the exit station 26, which images the ticket, decodes the bar codes, and raises the exit gate 28 upon confirming that all payments have been made. In some cases the bar code will then be returned to the user, along with an indication of how much was paid, so as to provide a receipt for the transaction.

In the depicted embodiment the pay station 30 and exit station 26 do not include attendants because payment is easily made without an attendant on site. However, it will be understood that the current system can also be used with an attendant, either at the exit station 26 or the central pay station 30. Most typically that attendant will be located at the exit station 26. Many parking facilities contain more than one exit station 26, and therefore it is sometimes appropriate to have an attendant at just a portion of the exit stations to be able to handle any questions or problems that arise. It will be understood, however, that the present invention provides the significant advantage of allowing a parking facility 34 to function without an on-site attendant.

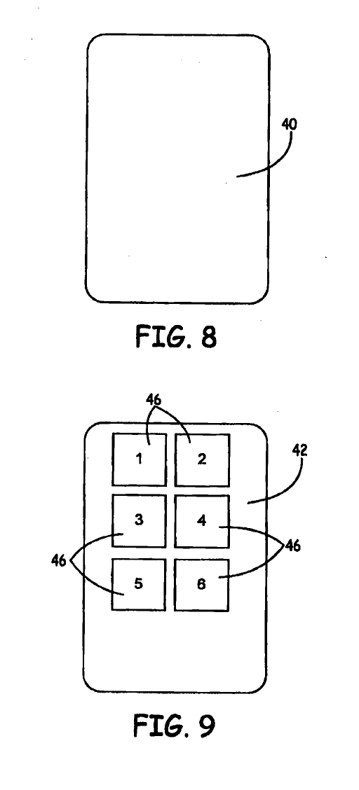

FIG. 8 shows a first implementation of a parking ticket prior to use. This parking ticket is entirely blank or mostly blank on the back side. The position of any bar codes to be placed on the parking ticket is determined by the printing mechanism, typically after being imaged. FIG. 4 shows an alternative configuration for a parking ticket 42, in which a plurality of squares 46 (with reference numbers 1 to 6 in the displayed embodiment) are outlined to indicate where bar codes are to be placed. The squares and reference numbers must be printed in a color and intensity that will not interfere with the imaging of bar codes. For example, the squares and reference numbers can be printed in a faint blue ink that will readily be printed over, and which can be ignored by the processing algorithm used to process the imaged bar codes. The benefit of having the squares and reference numbers is primarily that it allows manual placement of a bar code—such as one in the form of a sticker.

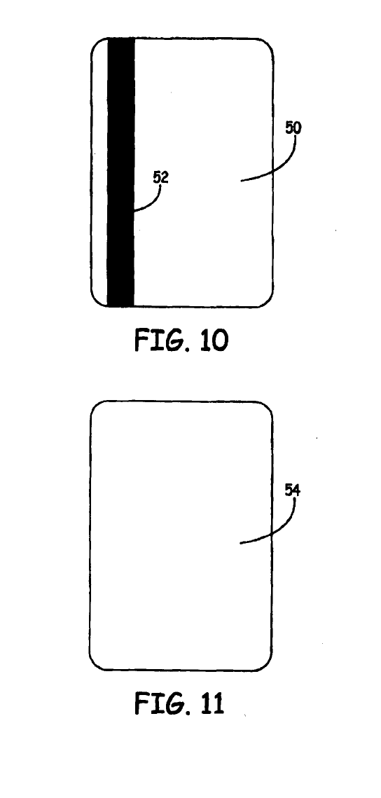

FIGS. 10 and 11 show alternatives for the opposite side of two parking tickets, 50 and 54. In FIG. 10 the parking ticket 50 includes a conventional magstripe 52, while the parking ticket 54 does not contain a magstripe. The use of a magstripe is optional, but provides an alternative or backup data storage location.

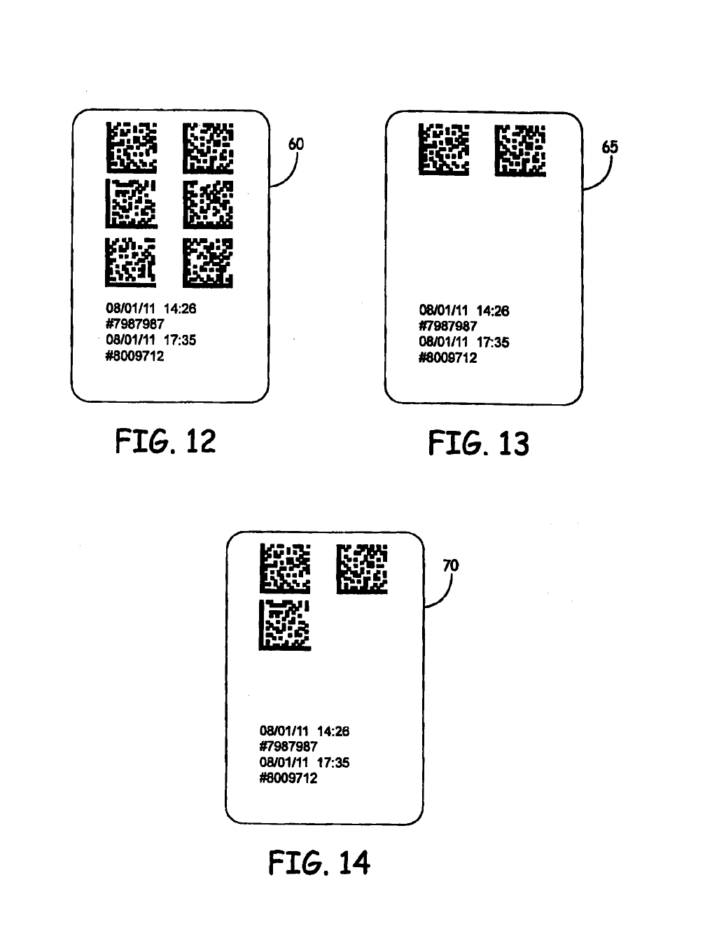

FIG. 12 shows a parking ticket 60 constructed and arranged in accordance with an implementation of the invention, the parking ticket displaying 6 two-dimensional bar codes. FIG. 13 shows a parking ticket 65 constructed and arranged in accordance with an implementation of the invention, the parking ticket displaying 2 two-dimensional bar codes. FIG. 14 shows a parking ticket 70 constructed and arranged in accordance with an implementation of the invention, the parking ticket displaying 3 two-dimensional bar codes. Alternative locations of the bar codes are also possible.

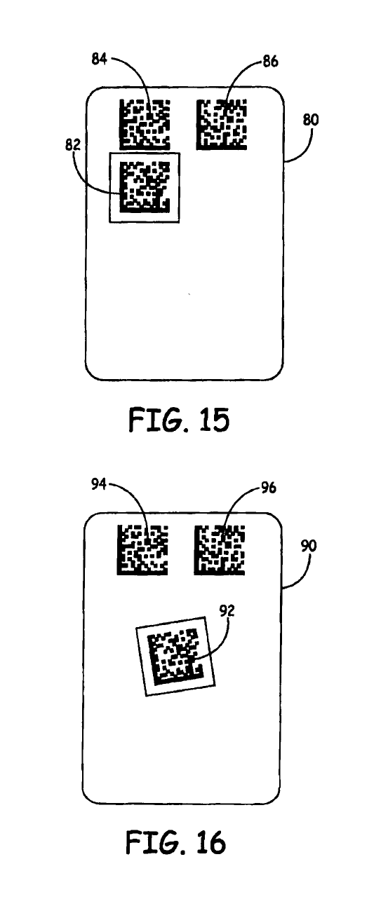

FIG. 15 shows a parking ticket 80 with a validation stamp 82 on it, along with two bar codes 84, 86 printed directly onto the ticket 80. The validation stamp 82, which includes a bar code, can be an adhesive stamp provided by a validating business. It is also possible to use an inking stamp for this purpose, although generally inked stamps fail to provide to adequate resolution or security. The validation stamp has significant benefits over prior manual validation methods, including the ability to automatically read the validation stamp, the ability to provide multiple validation stamps, etc. The validation stamp 82 typically contains encoded information allowing for a heightened security level relative to simple stamps that merely state a period of time or value. Such pre-existing systems are problematic because they do not readily account for issues of counterfeit validations or stolen validation stamps. In the present invention customized validation stamps can be provided for each validating organization, such as each business in an office building associated with a parking ramp. Also, these validation stamps can be individualized so that each stamp has its own identifier. In such situations stolen validation codes are readily recognized by automatic verification of validations by checking database entries and can be invalidated in the event that an attempt is made to use them.

FIG. 16 shows a second ticket 90 with a validation stamp 92 and two directly printed bar codes 94 and 96 on it. In this case the validation stamp 92 is rotated slightly relative to the printed bar codes 94 and 96, and is located in the center of the ticket 90. Imaging and processing of the face of the parking ticket 90 allows for recognition of the location and information on the parking ticket 96 despite the less than ideal placement. This is true, in part, because the bar code includes an identifier (such as two continuous edges) that can be recognized during processing. Also, the position of the stamp 92 allows the system of the invention, in particular the printer, to place additional subsequent bar codes at a location that will not overlap with the stamp 92. Also, in the alternative, it is possible and appropriate in some circumstances to print a new ticket to replace this ticket: For example, if the ticket is full or no space remains for additional bar codes (due to positioning of the stamp), then a new ticket can be issued that contains the necessary information from the old ticket. This new ticket may simply reprint the existing bar codes, but arrange them better, or it may print a new ticket with new data that combines data from the old ticket (such as the entrance time and total charges).

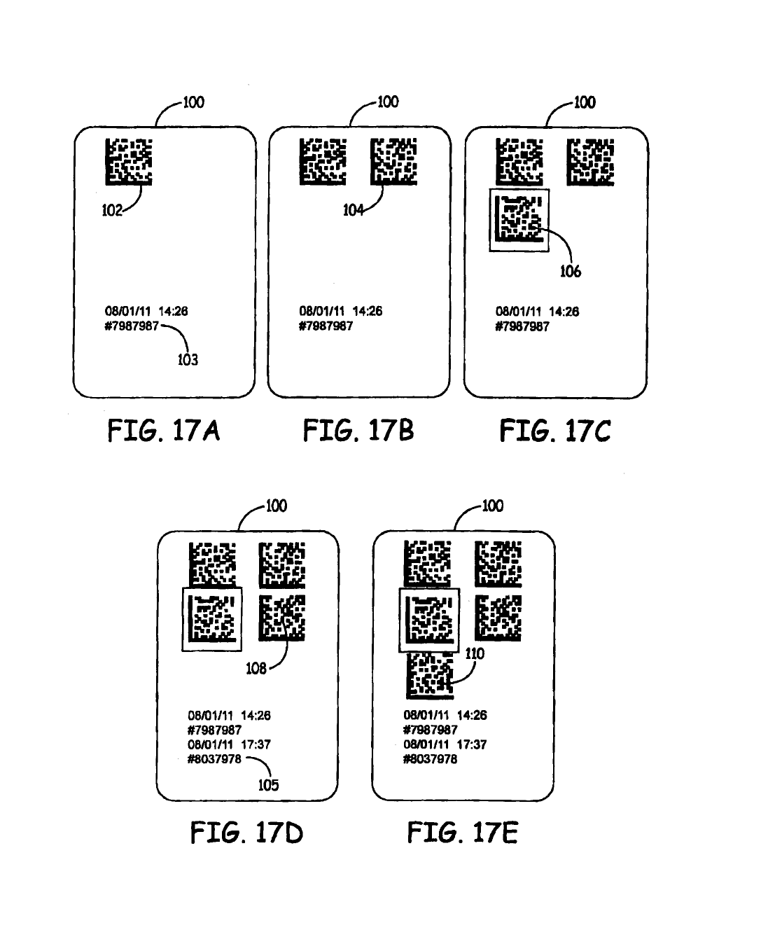

FIG. 17A to 17E show a single parking ticket 100 with a sequence of added two-dimensional bar codes. Specifically, FIG. 17A shows the ticket after dispensing from an entry station. The two dimensional bar code 102 will typically include an encrypted date and time for entry, as well as the entry location. Generally the bar code 102, like all bar codes used with the system, will have an error correction feature so that obscuring a small portion of the bar code (such as with a pen mark) will not destroy the ability to read it. FIG. 12B shows the ticket after having been validated with a printed validation bar code 104. This printed validation bar code could be provided at various locations, such as by a retailer or restaurant. The validation bar code could provide a dollar figure or a time figure (for example). FIG. 17C shows the ticket after validation with a sticker 106, again such as from a restaurant. Although FIGS. 17B and 17C show how validation functions can be handled using the system and method of the invention, it will be understood that validation is an is optional function, and not necessary for the operation of the system. Indeed, the majority of typical users in a typical parking facility are unlikely to need parking validation. FIG. 17D shows the ticket after being processed at a walk up pay station, wherein code 108 is printed to show that payment has been received. Generally this bar code will also state the time at which the payment was made, so that additional funds can be collected if a long time-lapse occurs between payment and exiting of the ramp. FIG. 17E shows just such a situation, where additional payment was necessary because a time delay occurred after the payment shown in FIG. 17D. This additional payment is desirably collected at a walk up pay station, but in some implementations can also be collected at the exit to the parking facility.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

1. A method for operating a parking facility, comprising:
storing real-time data relating to customer parking transactions in a database;
digitally imaging a parking credential such as a parking ticket, to obtain a digital image, the ticket comprising encrypted and visually-readable data relating to one or more customer transactions;
decrypting the encrypted customer transaction data;
calculating a fee corresponding to each customer transaction based on the decrypted customer transaction data;
verifying the calculated fee; and
verifying that the customer transaction data originating from the digital image matches real-time customer transaction data stored on the database.

2. The method of claim 1, further comprising the step of confirming encrypted data from the ticket image corresponds to transaction data in the database.

3. The method of claim 1, further comprising the step of confirming that the calculated fee from the ticket image equals the calculated fee from the database.

4. The method of claim 1, further comprising the step of maintaining a database record and a ticket database record, and then comparing transaction properties between them.

5. The method of claim 1, wherein for attendant operated terminals, maintaining a log of expected cash receipts per attendant per shift and generating a full report of cash to be collected at the end of the shift.

6. The method of claim 1, further comprising the step of keeping a running balance of credit card transactions and verifying transaction totals equal the amount transferred to merchant bank.

7. The method of claim 1, further comprising identification of a transaction having discrepancies between the calculated fee from the ticket image and the calculated fee from the database.

8. The method of claim 1, further comprising enforcement of data integrity by using digital signature/identifier preventing undetected tampering of the original data.

9. A system for real-time auditing of parking operations, the system comprising:
an image reader configured to review an encrypted image from a ticket, the encrypted image comprising data relating to a customer parking transaction;
a database configured to store real-time data relating to customer transactions;
one or more processors configured to decrypt the encrypted customer transaction data and verify that the data relating to the customer transaction from the image matches real-time customer transaction data stored in the database.

10. The system of claim 9, wherein a processor is associated with the image reader so as to decrypt the encrypted transaction immediately after capturing the encrypted image from the ticket.

11. A method of monitoring a parking facility
a) providing a bar code printer, the bar code printer configured to print bar codes on a surface;
b) providing a parking ticket, the parking ticket containing a surface for receiving printed bar codes;
c) printing a first bar code on the parking ticket, the first bar code relating to a first parking-related action; and
d) printing a second bar code on the parking ticket, the second bar code relating to a second parking-related action.

12. The method for monitoring a parking facility of claim 11, wherein at least the first or second bar code corresponds to the time of entering the parking facility.

13. The method for monitoring a parking facility of claim 11, wherein the parking ticket contains space for at least two bar codes.

14. The method for monitoring a parking facility of claim 11, wherein the parking ticket contains space for at least six bar codes.

15. The method for monitoring a parking facility of claim 11, wherein additional bar codes depend upon prior bar codes.

16. The method for monitoring a parking facility of claim 11, wherein the first parking-related action is entry into a parking ramp.

17. The method for monitoring a parking facility of claim 11, wherein the second parking-related action corresponds to payment of a parking fee.

18. The method for monitoring a parking facility claim 11, wherein at least one parking-related action corresponds to use of a vehicle charger.

19. The method for monitoring a parking facility of claim 11, further comprising adding a sticker containing a pre-printed bar code to the parking ticket.

20. The method of claim 11, further comprising recognition of the orientation of at least one of the bar codes.

21-26. (canceled)
